(19) United States
(12) Patent Application Publication
(10) Pub. No.: US 2018/0123917 A1
(43) Pub. Date: May 3, 2018

(54) SYSTEM AND METHOD FOR MONITORING MULTIPLE TERMINAL DEVICES

(71) Applicants: HONGFUJIN PRECISION ELECTRONICS (TIANJIN) CO.,LTD., Tianjin (CN); HON HAI PRECISION INDUSTRY CO., LTD., New Taipei (TW)

(72) Inventors: SHENG-CHUNG PAN, New Taipei (TW); YEN-HSUAN CHEN, New Taipei (TW); KUANG-CHAN TUNG, New Taipei (TW); YI-FENG LIN, New Taipei (TW); YIN-YEN CHIEN, New Taipei (TW)

(21) Appl. No.: 15/356,743

(22) Filed: Nov. 21, 2016

(30) Foreign Application Priority Data
Oct. 31, 2016 (CN) 201610933491.4

(51) Int. Cl. H04L 12/26; H04L 12/24

(52) U.S. Cl. CPC H04L 43/04; H04L 43/0817; H04L 41/0853; H04L 41/082; H04L 41/0672; H04L 41/0686

(57) ABSTRACT

A system for monitoring multiple devices in a network, which can be applied in a common server, includes setting a logging program into each terminal device whereby each terminal device updates and outputs a log file to the server at preset times. The coupling of a new IP address (of a new device) to the network can be detected. The system monitors all the devices for certain abnormalities and posts notifications to a manager concerning individual devices if such abnormalities occur. A device monitoring method is further provided.

### FIELD

The subject matter herein generally relates to a monitoring system and method for monitoring a plurality of terminal devices.

### BACKGROUND

A server manager generally monitors and services a plurality of terminal devices located at different network sites. The server manager can be coupled to the plurality of terminal devices through Internet Control Messages Protocol (ICMP) or Simple Network Server monitoring Protocol (SNMP).

### BRIEF DESCRIPTION OF THE DRAWINGS

Implementations of the present technology will now be described, by way of example only, with reference to the attached figures.

FIG. 1 is a sketch diagram of an exemplary embodiment of a device monitoring system.

FIG. 2 is a block diagram of the device monitoring system of FIG. 1.

FIG. 3 is a flow diagram of an exemplary embodiment of a device monitoring method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

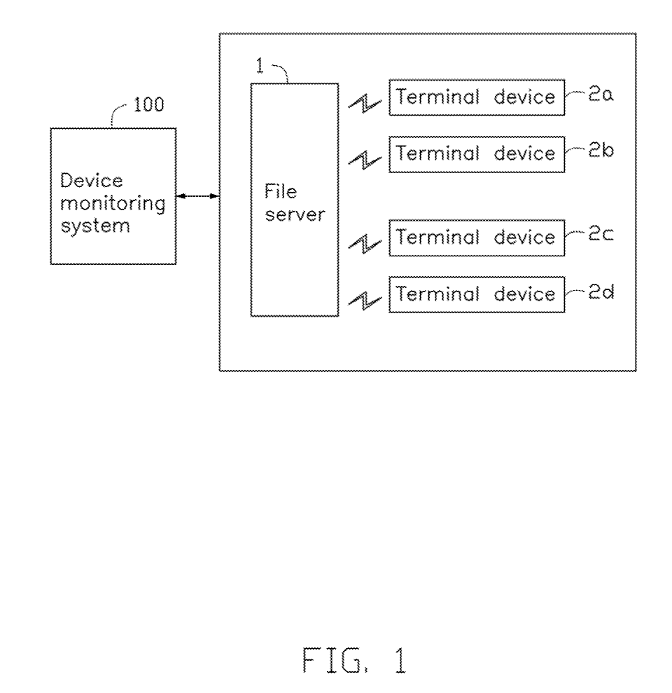

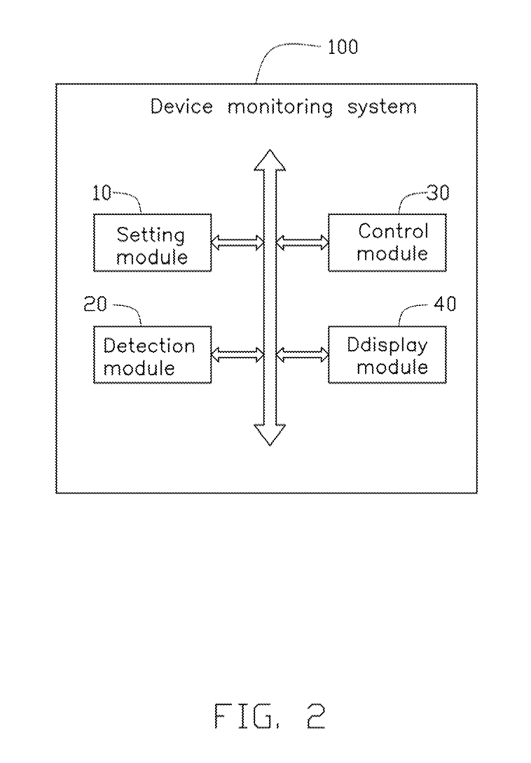

FIG. 1 and FIG. 2 illustrate a device monitoring system 100 in accordance with a first exemplary embodiment.

The device monitoring system 100 is configured to monitor the running status of each of a plurality of terminal devices. Each of the plurality of terminal devices is coupled to a file server. The plurality of terminal devices and the file server constitute a monitoring network, and the device monitoring system 100 is authorized to monitor the running status of each of a plurality of terminal devices in the monitoring network. In this exemplary embodiment, the plurality of terminal devices includes four devices 2a, 2b, 2c, and 2d. Each terminal device can be a server, a computer, or other electronic device.

The device monitoring system 100 can be installed in a file server or a personal computer. The device monitoring system 100 of this exemplary embodiment is installed in the file server 1.

The device monitoring system 100 obtains the running status of each of the terminal devices 2a, 2b, 2c, and 2d from the file server 1. The device monitoring system 100 can include a setting module 10, a detection module 20, a control module 30, and a display module 40.

The setting module 10 is configured to install a log tool into each terminal device 2a, 2b, 2c, and 2d, so that each terminal device 2a, 2b, 2c, and 2d can update and output a log file to the file server at preset times. The log tool can be a program file added in a log file feedback system. The log tool can define the preset time for updating the log file and outputting the updated log file. In at least an exemplary embodiment, the preset time is 30 seconds, so that each terminal device 2a, 2b, 2c, and 2d updates the log file and outputs the updated log file to the file server every 30 seconds.

In at least an exemplary embodiment, the log file can record: manager information, software information, version information, coupling status, temperature information of main heat-generating components, and running information of each terminal device 2a, 2b, 2c, and 2d. The main heat-generating components can include: CPU, peripheral component interface (PCI) chip, memory, and platform controller hub (PCH) chip. The manager can be a person who manages and maintains the corresponding terminal device.

The control module 30 is configured to receive the log file from the file server 1 and control the display module 40 to display the recorded information in the log file of each terminal device 2a, 2b, 2c, and 2d.

In at least an exemplary embodiment, the control module 30 is further configured to monitor whether the monitoring network is in an abnormal state based upon the information in the log file. Information regarding abnormalities is displayed by the display module 40, and a notification is sent to the manager. If at least one of the plurality of terminal devices is in an abnormal state, the monitoring network is deemed to be in an abnormal state.

Each of the plurality of terminal devices 2a, 2b, 2c, and 2d has a unique IP address. The detection module 20 is configured to detect a new IP address accessing or attempting to access the monitoring network. When a new IP address connects to/accesses the file server 1, a new device is regarded as accessing the monitoring network, and the detection module 20 adds the new IP address into the monitoring network. Such a new device can thus be monitored by the device monitoring system 100. The new device can be a new server or a new terminal device.

In at least an exemplary embodiment, the control module 30 is configured to detect the software version of each terminal device. When it is determined that the software version is not up to date, the control module 30 notifies the manager that the detected terminal device is in an abnormal state. The abnormality information is recorded, and then sent as a notification to the manager concerning a software updating.

In at least an exemplary embodiment, the control module 30 is configured to detect whether each terminal device is online. When a terminal device is detected to be offline, the control module 30 notifies the manager that the detected terminal device is in an abnormal state, and the abnormality is recorded and sent as a notification to the manager concerning a device not being online. In this exemplary embodiment, each terminal device sends the log file to the device monitoring system 100 every 30 seconds, thus the device monitoring system 100 can get a last log file before the abnormal terminal device goes offline, so that the manager can perform an offline analysis according to the last log file.

In at least an exemplary embodiment, the control module 30 is configured to detect whether the temperature of any of the main heat-generating components in each terminal device is over a preset temperature. When the temperature of any such component is over the preset temperature, the control module 30 notifies the manager that the detected terminal device is in an abnormal state, and records and sends notification of an abnormality concerning overheating to the manager. In this exemplary embodiment, the preset temperature of the CPU is about 85 degrees, the preset temperature of the PCI chip is about 85 degrees, the preset temperature of the memory device is about 95 degrees, the preset temperature of the PCH chip is 95 degrees, and the preset temperature of the BMC chip is about 90 degrees.

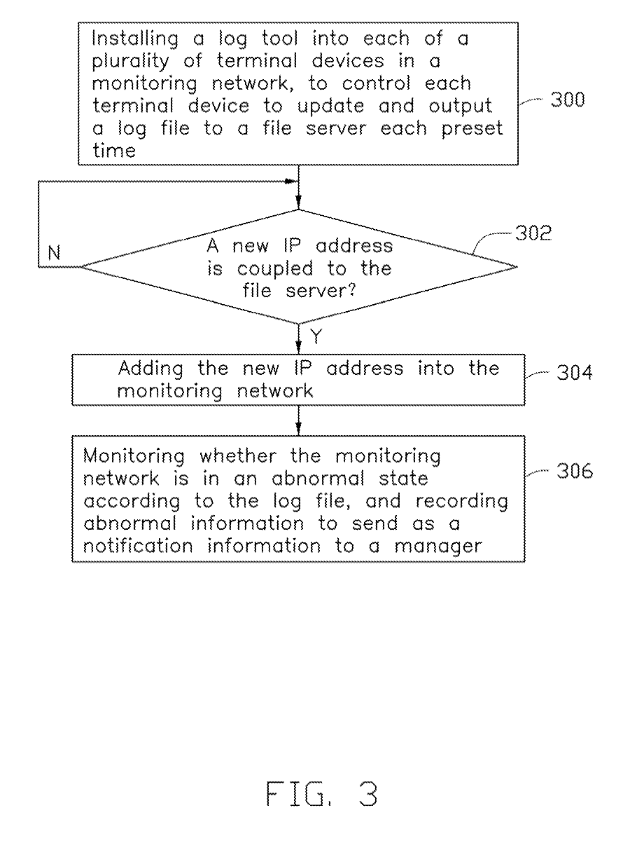

FIG. 3 is a flowchart depicting an exemplary embodiment of a device monitoring method. The method is provided by way of example, as there are a variety of ways to carry out the method. The exemplary method described below can be carried out using the configurations illustrated in FIGS. 1-2, for example, and various elements of these figures are referenced in explaining the example method. Each block shown in FIG. 3 represents one or more processes, methods, or subroutines, carried out in the example method. Furthermore, the illustrated order of blocks is illustrative only and the order of the blocks can change. Additional blocks can be added or fewer blocks may be utilized, without departing from the present disclosure. The example method can begin at block 300.

At block 300, the setting module 10 sets a log tool into each terminal device, and each terminal device updates and outputs a log file to the file server 1 at each preset time.

At block 302, the detection module 20 detects whether a new IP address is accessed into the monitoring network, if yes, block 304 is performed, if not, block 302 is performed.

At block 304, the detection module 20 adds the new IP address into the monitoring network.

At block 306, the control module 30 monitors whether the monitoring network is in an abnormal state according to the log file, and records abnormal information to display through the display module 40 and sends notification information to the manager.

The blocks 302 and 306 can be performed simultaneously.

In this exemplary embodiment, each of the plurality of terminal devices 2a, 2b, 2c, and 2d has a unique IP address.

In at least an exemplary embodiment, the block 306 can include: the control module 30 detects whether the software version of each terminal device is newest. When the software version is not up to date, the control module 30 notifies the manager that the detected terminal device is in the abnormal state, and then records the abnormal information to send a notification information, which triggers a software update request to the manager according to the manager information of the abnormal terminal device.

In at least an exemplary embodiment, the block 306 can further include: the control module 30 detects whether each terminal device is online. When the detected terminal device is offline, the control module 30 notifies the manager that the detected terminal device is in the abnormal state, and then records the abnormal information to send a notification information, which triggers an offline information request to the manager according to the manager information of the abnormal terminal device. In this exemplary embodiment, each terminal device sends the log file to the device monitoring system 100 about every 30 s, thus the device monitoring system 100 can get a last log file before the abnormal terminal device goes offline, so that the manager can perform an offline analysis according to the last log file.

In at least an exemplary embodiment, the block 306 can further include: the control module 30 which detects whether the temperature of each main heat generating component in each terminal device is greater than a corresponding preset temperature. When the temperature of any one main heat generating component is greater than the corresponding preset temperature, the control module 30 notifies the manager that the detected terminal device is in the abnormal state, and then records the abnormal information to send a notification information about the abnormal information, which reminds an overheating information, to the manager according to the manager information of the abnormal terminal device. In this exemplary embodiment, the corresponding preset temperature of the CPU is about 85 degrees, the corresponding preset temperature of the PCI chip is about 85 degrees, the corresponding preset temperature of the memory is about 95 degrees, the corresponding preset temperature of the PCH chip is about 95 degrees, and the corresponding preset temperature of the BMC chip is about 90 degrees.

The exemplary embodiments shown and described above are only examples. Many details are often found in the art such as the other features of a device monitoring system and method. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the exemplary embodiments described above may be modified within the scope of the claims.

What is claimed is:

1. A device monitoring method comprising:
installing a log tool into each of a plurality of terminal devices in a monitoring network, to control each terminal device to update and output a log file to a file server each preset time;
detecting whether a new IP address is coupled to the file server;
adding the new IP address into the monitoring network when the new IP address is coupled to the file server; and
monitoring whether the monitoring network is in an abnormal state according to the log file, and recording abnormal information to send as a notification information to a manager;
wherein the monitoring network comprises the file server and each terminal device coupled to the file server; and each terminal device has a unique IP address.

2. The device monitoring method of claim 1, wherein the log file records manager information, software information, version information, coupling status, temperature information, or running information of each terminal device.

3. The device monitoring method of claim 2, wherein monitoring whether the monitoring network is in an abnormal state according to the log file, and recording abnormal information to send notification information to a manager comprising:
detecting whether the software version of each terminal device is up to date;
wherein when the software version is not up to date, assigning the detected terminal device is in the abnormal state; and
recording the abnormal information to send a notification information, which also triggers a software update request to the manager according to the manager information of the abnormal terminal device.

4. The device monitoring method of claim 2, wherein monitoring whether the monitoring network is in an abnormal state according to the log file, and recording abnormal information to send notification information to a manager comprising:
detecting whether each terminal device is online;
wherein when the detected terminal device goes offline, assigning the detected terminal device is in the abnormal state; and
recording the abnormal information to send a notification information, which triggers an offline information request to the manager according to the manager information of the abnormal terminal device.

5. The device monitoring method of claim 2, wherein monitoring whether the monitoring network is in an abnormal state comprising:
detecting whether the temperature of each heat generating component in each terminal device is over a corresponding preset temperature;
wherein when the temperature of one heat generating component is over the corresponding preset temperature, assigning the detected terminal device is in the abnormal state; and
recording the abnormal information to send a notification information, which reminds an overheating information, to the manager according to the manager information of the abnormal terminal device.

6. The device monitoring method of claim 1, wherein when the new IP address is coupled to the file server, a new device is accessed into the monitoring network.

7. The device monitoring method of claim 6, wherein the new device is a new server or a new terminal device coupled to the file server.

8. The device monitoring method of claim 1, wherein the preset time is 30 s.

9. The device monitoring method of claim 1, further comprising receiving the log file from each terminal device and control a display module to display the recorded information in the log file of each terminal device.

10. The device monitoring method of claim 1, wherein the log tool is a program file added in a log file feedback system to define the preset time for updating the log file and outputting the updated log file.

11. A device monitoring system, comprising:
a setting module, the setting module configured to install a log tool into each of a plurality of terminal devices in a monitoring network, to control each terminal device to update and output a log file to a file server each preset time;
a detection module, configured to detect whether a new IP address is coupled to the file server and add the new IP address into the monitoring network when the new IP address is coupled to the file server; and
a control module, configured to monitor whether the monitoring network is in an abnormal state according to the log file, and record abnormal information to send as a notification information to a manager;
wherein the monitoring network comprises the file server and each terminal device coupled to the file server; and each terminal device has a unique IP address.

12. The device monitoring system of claim 11, wherein the log file records manager information, software information, version information, coupling status, temperature information, and running information of each terminal device.

13. The device monitoring system of claim 12, wherein the control module is further configured to detect whether the software version of each terminal device is up to date; assign the detected terminal device is in the abnormal state when the software version is not up to date; and record the abnormal information to send a notification information, which triggers a software update request to the manager according to the manager information of the abnormal terminal device.

14. The device monitoring system of claim 12, wherein the control module is further configured to detect whether each terminal device is online; assign the detected terminal device is in the abnormal state when the detected terminal device goes offline; and record the abnormal information to send a notification information, which triggers an offline information request to the manager according to the manager information of the abnormal terminal device.

15. The device monitoring system of claim 12, wherein the control module is further configured to detect whether the temperature of each heat generating component in each terminal device is over a corresponding preset temperature; assign the detected terminal device is in the abnormal state when the temperature of one heat generating component is over the corresponding preset temperature; and record the abnormal information to send a notification information, which reminds an overheating information, to the manager according to the manager information of the abnormal terminal device.

16. The device monitoring system of claim 11, wherein when the new IP address is coupled to the file server, a new device is accessed into the monitoring network.

17. The device monitoring system of claim 16, wherein the new device is a new server or a new terminal device coupled to the file server.

18. The device monitoring system of claim 11, wherein the preset time is 30 s.

19. The device monitoring system of claim 11, wherein the control module is further configured to receive the log file from each terminal device and control a display module to display the recorded information in the log file of each terminal device.

20. The device monitoring system of claim 11, wherein the log tool is a program file added in a log file feedback system to define the preset time for updating the log file and outputting the updated log file.
